(19) United States
(12) Patent Application Publication
(10) Pub. No.: US 2010/0163794 A1
(43) Pub. Date: Jul. 1, 2010

(54) Oxidizing composition including a gel layer

(76) Inventor: Roy W. Martin, Downers Grove, IL (US)

Correspondence Address: Roy W. Martin, 1440 Palmer, Downers Grove, IL, 60516, US

(21) Appl. No.: 12/653,984

(22) Filed: Dec. 22, 2009

Related U.S. Application Data
(63) Continuation-in-part of application No. 12/380,329, filed on Feb. 26, 2009.
Application No. 12/380,329 is a continuation-in-part of application No. 11/253,977, filed on Oct. 18, 2005, now Pat. No. 7,534,368.
Application No. 11/253,977 is a continuation-in-part of application No. 11/154,086, filed on Jun. 15, 2005, now Pat. No. 7,514,019.
Application No. 11/154,086 is a continuation-in-part of application No. 11/070,132, filed on Mar. 1, 2005, now abandoned.

(51) Int. Cl. C01B 11/02

(52) U.S. Cl. 252/187.23

(57) ABSTRACT

A composition that generates and releases a biocidal solution comprising at least chlorine dioxide and free halogen is presented. The composition comprises reactants capable of in-situ generation of chlorine dioxide and free halogen donor, and a gelling agent that slows the rate of dissolution of the reactants, thereby increasing yield and providing a controlled release of biocidal solution. The compositions of the invention show improved environmental stability which can reduce the cost of packaging. The controlled release allows the use in multi-tablet chemical dispensers which may otherwise induce potentially explosive conditions or allow rapid release of the biocidal solution thereby inducing a spike in chemical concentration rather than a sustained release.

### RELATED APPLICATIONS

This application is a Continuation-in-Part (CIP) of U.S. patent application Ser. No. 12/380329 filed on Feb. 26, 2009, which in turn a CIP of U.S. patent application Ser. No. 11/253,977 filed on Oct. 18, 2005, which is in turn a CIP of U.S. patent application Ser. No. 11/154,086 filed on Jun. 15, 2005, which is in turn a CIP of U.S. patent application Ser. No. 11/070,132 filed on Mar. 1, 2005. The contents of these patent applications are incorporated by reference herein.

### FIELD OF INVENTION

This invention relates generally to an oxidizing compound and more particularly to a biocidal oxidizing compound that is stabilized for bulk packaging, provides a controlled release of chlorine dioxide and free halogen; and is suitable for use in multi-tablet chemical dispensers.

### BACKGROUND

Oxidizing biocides are commonly used for the treatment of recirculating systems. It is common for tablet forms to be applied thru feeders such as flow through chlorinators or brominators. However, in many instances chlorine and bromine alone are not sufficient for the control of microbiological activity.

Chlorine dioxide has been shown to be very effective for the control of microbiological organisms in Oxidizers. However, cost effective generation of chlorine dioxide requires on-sight generation from liquid reagents and substantial capital investment.

In recent years, tablets that generate chlorine dioxide have been developed, however their use in the treatment of recirculating systems is very limited due to high use cost and limited utility. High use cost is attributed to the tablet's relatively low yields of chlorine dioxide and poor environmental stability that requires costly individual packaging of the tablets. Also, the high reactivity and rapid release of the chlorine dioxide results in a spike of treatment rather than the desirable controlled release to achieve a sustained concentration of treatment, and subsequent potential for generation of explosive conditions when applied in multi-tablet chemical dispensers due to elevated levels of potentially explosive gas.

U.S. Pat. No. 6,699,404 to Speronello (“the Speronello patent”) discloses a massive body having a porous structure which substantially increases the percent conversion of chlorite to chlorine dioxide when compared to chlorite powder. The Speronello patent discloses two types of massive bodies: a water soluble type and a substantially water insoluble type. The substantially water insoluble massive body forms a porous framework that provides a higher efficiency of the conversion compared to the water-soluble massive body. According to the test data provided in the Speronello patent the maximum concentration of chlorine dioxide produced by a massive body that forms the porous framework is 149.4 mg/L. The water-soluble massive body reported (example 4) a maximum 27.4 mg/L.

In order to achieve 70% or more conversion of the chlorite to chlorine dioxide using the method disclosed in the Speronello patent, a substantial amount of inert materials are added to produce the porous structure or the porous framework. The level of inert salts ranges from 18 wt. % to 80 wt. %, with higher weight percentages increasing the conversion efficiency. The high levels of inert material, particularly in the water-soluble massive body, are further illustrated in commercial practice. For example, Aseptrol®, which is the commercialized product embodying the invention disclosed in the Speronello patent, is a water soluble tablet that requires 1.5 grams of Aseptrol® to 1 liter of water to produce 100 mg/L chlorine dioxide. This equates to approximately 67 mg/L chlorine dioxide based on 1 gram tablet per liter. The weight-% yield, which is defined as weight chlorine dioxide per weight of tablet, is low because of the high level of inert material. According to the data reported in the Speronello patent, the weight % yield is less than 15 wt. % , and less than 3% in the case of the water-soluble massive body. Based on the commercial product Aseptrol®, the weight percent yield of the water soluble commercial product is 6.7 wt. %.

It is desirable to increase the concentration of chlorine dioxide produced by a given mass of tablet to improve the economics based on the cost per pound of the tablet material versus pounds of chlorine dioxide produced. Such increase would also result in an overall performance enhancement offered by higher concentrations of chlorine dioxide. To achieve this objective, tablet conversion efficiency of >70% and a high reactant weight percent are desirable. It is also desirable to substantially increase the concentration of chlorine dioxide using a completely water-soluble composition to eliminate the problems associated with water insoluble constituents or byproducts such as residue silica based clays, or mineral salts such as calcium sulfate.

U.S. Pat. Nos. 6,384,006 and 6,319,888 to Wei et al. (“the Wei patents”) disclose a system for forming and releasing an aqueous peracid solution. The system includes a container and a peracid forming composition that includes about 10-60 wt. % of a chemical heater that, upon contact with water, generates heat to increase the yield of the peracid.

The Wei patents describe the potential use of a viscosity modifier within a permeable container to increase the viscosity in the localized area from about 300 to about 2,000 centipoise. The increased viscosity restricts and slows down the movement of peracid precursor and/or peroxygen source out of the permeable container. This results in an increased residence time of the peracid precursor and peroxygen source within the permeable container, which in turn translates to a greater reaction rate.

U.S. Pat. No. 6,569,353 to Giletto et al. (“the Giletto patent”) discloses using silica gel to increase the viscosity of various oxidants including an in-situ generated oxidant in order to keep them in intimate contact with the agents targeted for oxidation.

U.S. Published Application No. 2001/0012504 to Thangaraj et al. (“the Thangaraj application”) discloses a composition for producing chlorine dioxide comprising an acid source and a chlorite source, and a method comprising enclosing the composition in a gelatin capsule or membrane sheet such as a “tea bag”.

U.S. Pat. No. 5,688,515 discloses a composition comprising trichloroisocyanuric acid, sodium bromide, and dimethylhydantoin to produce hypobromous acid.

Patent Application WO 2007/078838 discloses a composition comprising an oxidizer and bromide donor along with a chlorite donor to produce chlorine dioxide. The compositions disclosed generate chlorine dioxide rapidly and preferably without the use of chlorine donors such as chlorinated isocyanurates. The compositions also require special packaging to prevent chlorine dioxide generation resulting from relative humidity.

In order to improve reaction kinetics, the above references teach using substantial quantities of inert materials to either provide a porous structure as in the case of the Speronello patent, or heat as in the cases of the Wei patents. While viscosity modifiers are referenced in the Wei patents, the viscosity range disclosed in the Wei patents does not reflect the formation of a gel.

Search still continues for a method of stabilizing reactive components for storage without compromising or limiting their function during usage.

### SUMMARY

In one aspect, the invention is a composition that generates a target product and releases a biocidal solution containing the target product. The composition comprises reactants capable of generating the target product through a chemical reaction, a halogen that is capable of synergistically providing a biocidal effect with the target product, and a gel-forming material. The chemical reaction is triggered when the reactants are contacted by a main solvent. The reactants include a free halogen donor that makes up about 39.9-90.9 weight % of the composition and a chlorite donor that makes up about 9-60 weight % of the composition. The gel-forming material, which is in contact with the reactants, makes up about 0.1 to 10 weight % of the composition. Upon being exposed to the main solvent, the gel-forming material forms a gelatinous structure that creates a chamber within the composition enclosing some of the reactants such that the target product is generated in the chamber, wherein the gelatinous structure restricts diffusion of the reactants and the target product out of the chamber, restricts the diffusion of the main solvent into the chamber, and wherein the gelatinous structure dissipates when a depletion level is reached inside the chamber. Different parts of the composition are exposed to the main solvent at different times.

In another aspect, the invention is a composition that releases chlorine dioxide and free halogen at a controlled rate thereby providing a biocidal solution for an extended period of time and allowing use in multi-tablet chemical dispensers. Tablets can be designed to release the biocidal solution over hours or days instead of a rapid release of chlorine dioxide like compositions disclosed in the reference prior art.

In another aspect, the invention is a method of producing a composition that generates a target product and releases a biocidal solution containing the target product. The method entails forming an agglomerate of reactants that when contacted by an aqueous solution produce in-situ generated chlorine dioxide, and coating the agglomerate of reactants with a slow-dissolving free halogen donor.

In another aspect, the invention is a composition that is environmentally stable and allows bulk packaging. Tablet that generate chlorine dioxide are packaged as individual compartments or individually wrapped to protect from relative humidity and premature release of chlorine dioxide. The tablets of the invention are sufficiently stable as to allow bulk packaging wherein multiple tablets are provided in one package. This substantially reduces cost.

### BRIEF DESCRIPTION OF THE DRAWINGS

FIG. 1 is an exemplary embodiment of reactor in accordance with the invention.

FIG. 2 is the reactor of FIG. 1 after the solvent interface has been exposed to the main solvent.

FIG. 3 is the reactor of FIG. 1 after the reactant concentrations inside the activated reaction chambers have reached the depletion level.

FIG. 4 shows the changes at the solvent interface for a first embodiment of the reactor made with a gelling agent.

FIG. 5 shows the changes at the solvent interface for a second embodiment of the reactor made with a binder.

FIG. 6 illustrates an embodiment of the composition whereby an in-situ generating portion of the composition is encapsulated by a coating comprising a free halogen donor.

FIG. 7 illustrates an embodiment of the composition whereby an in-situ generating portion is sandwiched between two layers of at least one free halogen donor.

### DETAILED DESCRIPTION OF THE EMBODIMENT(S)

The invention is particularly applicable to generation and release of oxidizers that have bleaching, biocidal, or virucidal properties and it is in this context that the invention will be described. It will be appreciated, however, that the reactor, the method of making the reactor, and the method of using the reactor in accordance with the invention has greater utility and may be used for any other target product(s). Although the main solvent is described as water for clarity of illustration, the invention is not so limited.

“Reaction chamber” is a space that is defined by the outline of a colloidal gel wall, and includes the enclosed by the colloidal gel, the colloidal gel itself, and any pores or channels in the colloidal gel. A “main solvent,” is any solvent that dissolves the reactant(s) and triggers a chemical reaction. A “polymer,” as used herein, includes a copolymer. A substance that is transported at a “controlled rate” does not cross a physical boundary explosively all at once but gradually, over a desired period of time.

As used herein, “depletion level” indicates a predetermined concentration level of the reactant(s) and the target product in a reaction chamber. When a reaction chamber is contacted by the main solvent, a chemical reaction is triggered and the reactant(s) in the reaction chamber are converted to the desired target product. The target product then leaves the reactor chamber at a controlled rate. The depletion level may be defined by parameters other than reactant concentration that also indicate the rate of target product generation, such as the pH level or the concentrations of the target product or a byproduct.

When the reactor wall “disintegrates,” it could collapse due to a pressure difference between the inside and the outside of the reactor, dissolve in the main solvent, or come apart and dissipate due to forces applied by the movement in the main solvent. A membrane is a porous material that allows permeation of the solvent and diffusion of the product. “Water,” as used herein, is not limited to pure water but can be an aqueous solution. A gelatinous structure “dissipates” by dissolving or dispersing in the main solvent.

“Gel,” “hydro-gel,” and its various derivations (i.e. gelatinous) describes a material or composition of materials that undergo a high degree of cross-linking or association when hydrated and dispersed in the dispersing medium, or when dissolved in the dispersing medium. This cross-linking or association of the dispersed phase will alter the viscosity of the dispersing medium to a level which restricts the movement of the dispersing medium. As used herein, “suspension” refers to a two-phase system consisting of a finely divided solid dispersed (suspended) in a liquid (the dispersing medium). Gels contain suspended particles but are different from suspensions in that these suspended particles create a three-dimensional structure of interlacing particles or solvated macromolecules that restrict the movement of the dispersing medium.

A “gel-forming material” is comprised of at least a polymer that, upon contact with a hydrophilic solvent, produces a hydrocolloid or hydro-gel. The polymer can be natural, such as a gum (i.e. Xanthun gum), semisynthetic such as a polysaccharide (i.e. cellulose derivative), or synthetic such as a poloxamer or carbomer.

A “stiffening agent” can be water-soluble or substantially water-insoluble. When combined with a gel-forming material, the stiffening agent substantially increases the viscosity of the gel-structure to a level where the gel increases its rigidity to where the gel-structure restricts the movement or dispersion of the gel. Stiffening agent can be a cross-linking agent such as when borate is combined with polyvinyl alcohol.

A “stiffening agent comprising boron” can be any source of boron containing compound that cross-links with polyvinyl alcohol under the conditions achieved within the gelatinous structure. Examples include but are not limited to: boric acid, borax and its varying hydrated forms and mixtures.

A “gelatinous structure” comprises the three-dimensional hydrocolloid or hydro-gel produced by the hydrolysis of the gelling agent, which may include at least one natural, semi-synthetic, and synthetic hydrocolloid forming polymer, as well as any reactants or products restrained or trapped by the three-dimensional gel. The gelatinous structure describes a region defined by the coalesced gelatinous composition which forms the 3-dimensional structure. The regional boundaries are generally defined by the innermost portion of the gelatinous composition (approaching the center of the agglomerate) to the outermost boundary of the gelatinous composition (interfacing with the bulk of the dispersing medium). The gelatinous structure may have both pseudoplastic and thixotropic properties, and achieve a viscosity gradient across the region.

A “gelling agent” defines the components required to produce the gelatinous structure. The gelling agent includes at least the gel-forming material. However the gelling agent may also include a stiffening agent, pH buffer, etc.

A “granule” is an agglomerate of reactant(s) typically having a particle size less than 1 mm. When a granule is coated with a gel-forming material, each coated granule functions as an independent reactor. The granules may be coated with a fluidized bed drier and an atomized spray. However, granules may also be coated with a powder of an additive, then combined with other components such as a free halogen donor before being agglomerated again.

If the gel contains small discrete particles, the gel is called a “two-phase system.” Two-phase systems are thixotropic, i.e., they are semisolid on standing but liquefy when shaken. Two-phase systems are formed when substantially water-insoluble additives are combined with the gel-forming material. If the particle size in a two-phase system is large, the gel is referred to as a magma. Examples of two-phase systems include aluminum hydroxide gel and bentonite magma.

“Single-phase system” If the gel does not appear to have discrete particles, it is called as a one-phase system. Single-phase systems contain linear or branched polymer macromolecules that dissolve in water and have no apparent boundary with the dispensing medium. These macromolecules are classified as natural polymers.

“Thixotropic” indicates the property exhibited by certain gels of becoming fluid when stirred or shaken and returning to the semisolid state upon standing.

“Pseudoplastic” indicates the property exhibited by gels where the gel retains a high viscosity at low shear rates (during storage) and low viscosity at high shear rates (during shaking, pouring, or spreading).

As used herein, the term “controlled release” refers to the compositions ability to produce and release in-situ generated chlorine dioxide and free halogen over an extended period of time rather than a rapid release. Depending on the tablet size, when contacted with an aqueous solution, the composition will produce a solution consisting of chlorine dioxide and free halogen over a period of about 30 minutes to many days.

As used herein, the term “tablet” refers to any geometric shape or size that comprises the components necessary to produce a solution consisting of chlorine dioxide and free halogen, and wherein the components are gathered together to form one single mass.

As used herein, the term “halogenated cyanuric acid” refers to any combination of chlorinated or chlorinated and brominated cyanuric acid compounds. Examples include but are not limited to trichloroisocyanuric acid, bromochloroisocyanuric acid.

As used herein, the term “slow dissolving” refers to the tablets of the invention having a restricted rate of dissolution compared to the rate of dissolution achieved from a tablet of similar composition that does not comprise a gelling agent. The gelling agent restricts the dissolution of the reactants thereby slowing the rate at which the tablet dissolves, and allows for a sustained release of in-situ generated products rather than a rapid release obtained by fast dissolving masses and powders.

As used herein, the term “free halogen donor” describes a source of free halogen that when dissolved in an aqueous solution contributes at least one of Cl₂, HOCl, OCl⁻, Br₂, HOBr, OBr⁻ the species of which is dependent on the solution pH. Examples sources of free halogen donors include but are not limited to chlorinated cyanuric acid, chlorinated and brominated cyanuric acid, and brominated and/or chlorinated hydantoin. Examples include but are not limited to: trichloroisocyanuric acid, potassium chlorobromoisocyanurate dibromodimethylhydantoin, bromochlorodimethylhydantoin.

As used herein, the term “free halogen” refers to free chlorine comprising any combination or proportion of hypochlorous acid and hypochlorite ions and/or free bromine comprising any combination of hypobromous acid and hypobromite ions.

As used herein, the term “multi-tablet chemical dispensers” describes any convenient feed system that holds multiple tablets of the invention and contacts at least some portion of the tablets with an aqueous solution to produce a solution consisting of chlorine dioxide and free halogen. Examples include flow-thru brominators such as those sold by Great Lakes Water Treatment and Nalco Chemical, spray feeders like those sold by Arch Chemical and sold under the trade name Pulsar, and floating dispensers.

As used herein, the term “bulk packaging” defines the ability to package multiple tablets into one package without segregating each tablet. Example packaging includes but is not limited to plastic bags and plastic pails.

As used herein, the term “coated” refers to the application of the gel-forming material or gelling agent onto the surface of a reactant. Coated may also refer to the encapsulation of the reactant by the gel-forming material or gelling agent.

As used herein, the term “surrounds” refers to the free halogen donor's position in relation to the in-situ generating portion of the composition. Surrounds includes encapsulates, sandwiches as in the case of two layers of free halogen donor with the in-situ generating portion between the two free halogen layers.

As used herein, the term “chlorite donor” is a substance that contributes chlorite anions having the formula ClO₂⁻ when dissolved in an aqueous solution. The chlorite donor will generate chlorine dioxide when reacted with hypochlorous acid and/or hypobromous acid. An example of a suitable chlorite donor is sodium chlorite.

As used herein, the phrase “chlorite conversion to chlorine dioxide” describes the amount of chlorite anion having the general formula ClO₂⁻ into the in-situ generated product chlorine dioxide having the general formula ClO₂. The amount of conversion is reported in weight percent and is determined by dividing the measured amount of chlorine dioxide produced by the total amount of chlorite anion in the composition. The equation is represented by ClO₂/ClO₂⁻×100=weight percent

As used herein, the term “recirculating systems” describes any open aqueous system that consist of a reservoir of water and a system of piping to transport the water, and wherein the water transported through the piping is eventually returned to the reservoir. Examples of recirculating systems include but are not limited to: cooling systems comprising cooling towers, swimming pools, fountains and feature pools.

As used herein, the term “biocidal solution” describes an aqueous solution consisting of at chlorine dioxide and free halogen resulting from contacting an aqueous solution with the slow dissolving tablet composition if the invention.

To maximize the yield in a chemical reaction, it is usually preferable to start with high concentrations of reactants because the molar concentrations of the reactants determine the rate of reaction and the subsequent product yield. Therefore, adding reactants to a large body of water to be treated is not an effective way to generate the desired product in-situ. Adding the reactants to the water lowers the reactant concentrations, and the resulting conversion of the reactants to the desired product(s) is generally poor. Another factor to be considered is the side reactions. When generating an agent in-situ, the oxidizer reactant is often consumed in reactions other than those desired for the in-situ production of the target product. Therefore, adding the reactants to the water to be treated results in more reagent requirements, longer reaction time, and/or an overall decreased yield of the target product.

Furthermore, the chemical environment, such as pH, can adversely affect the in-situ production of the target product. For example, reactions that are acid catalyzed are not supported in alkaline conditions such as laundry wash water. By isolating the reactants and controlling the conditions inside the reactor, efficient generation of the target product(s) occurs regardless of the conditions external to the reactor.

When an oxidizer, such as potassium monopersulfate (PMPS), is added to water to convert sodium chloride to hypochlorous acid through a hypohalite reaction, the conversion or yield is dependent on the molar concentrations of the reactants. As described above, however, adding a given amount of reactants to a large volume of water yields poor conversion to the target product. Furthermore, potassium monopersulfate is highly reactive with organic chemical oxygen demand (COD). Thus, upon being exposed to the bulk solution, the PMPS reacts with the COD and further reduces the concentration of PMPS that is available to induce the hypohalite reaction.

The invention is based on the concept that a high yield can be maintained by controlling the rate at which the reactants are exposed to water. More specifically, if the reactants were first exposed to a small volume of water and allowed to react to generate the target product, a high yield of the target product can be obtained because the reactant concentrations will be high. Then, the target product can be exposed to a larger volume of water without compromising the yield. The rate at which the reactants are exposed to water has to be such that the target product is generated in high-yield before more water dilutes the reactants. The invention controls the reactants’ exposure to water by coating the reactants with a material that allows water to seep in and reach the reactants at a controlled rate.

The invention is also based on the fact that chlorine dioxide makes an effective biocide with advantages over other common oxidizing biocides. Chlorine dioxide, when combined with other halogen biocides, provides a synergistic effect that increases the inactivation rate of organisms at a higher rate than either biocide fed alone.

However, thus far, the oxidizing power of chlorine dioxide has not been fully exploited because the cost of equipment to produce chlorine dioxide in-situ to the application is prohibitively high. Also, when using conventional powders or tablets, the economics are severely compromised due to poor “weight % yield” of the powders and tablets as well as the cost of producing these chlorine dioxide generators. The poor “weight % yield” is demonstrated in the ‘404 Patent discussed above.

Depending on the embodiment, the invention may be a reactor that is stable enough for storage and useful for generating high yields of products in-situ, product including oxidizers, biocides, and/or virucidal agents. A “soluble” reactor has walls that dissolve in the main solvent after the reaction has progressed beyond a certain point (e.g, the depletion level has been reached). The soluble reactor is stable when dry. When mixed with a main solvent (e.g., water), however, the coating material that forms the outer wall of the soluble reactor allows the solvent to slowly seep into the reactor space, dissolve the reactant(s), and trigger a chemical reaction. The chemical reaction generates a target product. Since the concentrations of the reactants are high within the soluble reactor, a high yield of the target product is achieved inside the reactor. After the reactor space reaches the predetermined depletion level, the coating material disintegrates.

In some embodiments, the reactor of the invention is a “micro-reactor” having a diameter or width in the range of 10-2000 μm. However, the reactor is not limited to any size range. For example, the reactor may be large enough to be referred to as a pouch. A single reactor may be both a micro-reactor and a soluble reactor at the same time. Furthermore, a reactor may have a soluble wall and a non-soluble wall.

### Reactancts

Reactants are selected to induce the formation of the desired product(s). When determining the ratio of reactants, consideration should be given to the desired ratio of products. Single species generation of agent is achieved with proper optimization of reagent ratios.

The reaction chambers 20 contain reactants that, upon dissolution to form a liquid phase, induce the in-situ generation of the chlorine dioxide and hypobromous acid.

### Chlorine Dioxide

In one embodiment, the composition comprises from about 5-60 wt % of chlorite donor exemplified by sodium chlorite, 39.9-94.9 wt % of a free halogen donor exemplified by dibromodimethylhyantoin, and from 0.1 to 10 wt % of a gelling agent exemplified by polyvinyl alcohol. The gelling agent may include a stiffening agent such as borax or boric acid in the case of polyvinyl alcohol.

The gelling agent will be comprised of at least a polymer that, upon contact with a hydrophilic solvent, produces a hydrocolloid or hydro-gel. The polymer can be natural, such as a gum (i.e. Xanthun gum), semisynthetic such as a polysaccharide (i.e. cellulose derivative), or synthetic such as a poloxamer, carbomer and polyvinyl alcohol. Additional stiffening agents such as incorporating borax with polyvinyl alcohol can be used to increase the viscosity and further reduce dissolution rates of the reactants.

Additional additives such as pH buffers maybe included depending on the reactants used as well as the final application. For example in cases where trichloroisocyanuric acid (TCCA) is included, the acidity from the TCCA may be sufficient to neutralize the alkalinity from the chlorite donor. However, in applications where dibromodimethyl hydantoin (DBDMH) is used, additional acidity maybe required since DBDMH has a pH near neutral.

### Optional Components in the Reactor

### 1) Fillers

Fillers can be used or altogether omitted depending on the type of processing and the requirements of the use of the final product. Fillers are typically inorganic compounds such as various mineral salts, metal oxides, zeolites, clays, aluminates, aluminum sulfate, polyaluminum chloride, polyacrylamide, and the like.

2) pH Buffers

A pH buffer, which is an optional component of the reactor 10, provides a source of pH control within the reactor. The pH buffers can be inorganic (e.g. sodium bisulfate, sodium pyrosulfate, mono-, di-, tri-sodium phosphate, polyphosphates, sodium bicarbonate, sodium carbonate, boric acid, borax, and the like). Organic buffers are generally organic acids with 1-10 carbons such as succinic acid.

The pH buffer can be employed to adjust the pH of the solution resulting from the dissolution and reactions resulting from the composition in order to achieve the desired conversion of chlorite to chlorine dioxide and/or achieve the desired viscosity of the gel.

### 3) Stabilizers

Examples of stabilizers include but are not limited to N-succinimide, isocyanuric acid, hydantoin and the like. When stabilization is not required to generate these compounds, they can be omitted. However, it is desirable to include a stabilizer such as hydantoin when bromide anions are activated by free halogen donors comprising chlorine or other oxidizers such aqs potassium monopersulfate to activate the bromide to produce free bromine such as hypobromous acid. Without stabilization the excess free bromine can compromise the chlorine dioxide stability.

4) Cross-Linking Agents

Cross-linking agents, which are additives that change the physical or chemical properties of the composition, may be added to the reactor to control (e.g., reduce) the dissolution rate of the composition. For example, glycoluril is effective at bonding with hydroxyl and carboxylic acid groups such as those found in the cellulose of hydrolysed silicates. Glycerin and borates alter the water permeation rate of polyvinyl alcohol. Therefore, these types of agents can be added or left out depending on the final dissolution rate, hygroscopicity, chemical resistance to oxidizers, etc.

A cross-linking agent is mixed with the binder, and the mixture is combined with the reactants in the manner described above. In cases where curing is required to set the cross-linking agent, the binder and the cross-linking agent are combined in the presence of a solvent and/or a curing agent, mixed, and reacted. If needed, the mixture is dried prior to application (e.g., being combined with the reactants).

5) Stiffening Agent The stiffening agent is used to

increase the viscosity of the gel. Which stiffening agent is used depends on the type of polymer being employed. Polyvinyl alcohol contains hydroxyl groups that have the ability to cross-link with borax. It is thought that other compounds that combined with hydroxyl groups such as glycoluril will also function as stiffening agents when used with polyvinyl alcohol.

### A. Structure

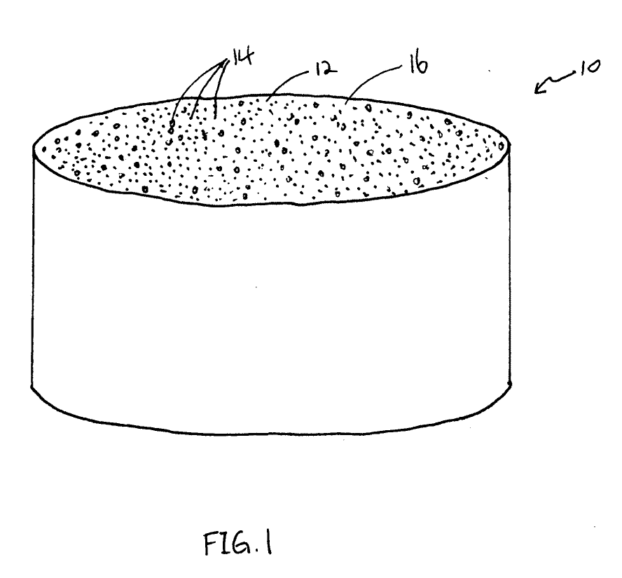

FIG. 1 is an exemplary embodiment of reactor 10 in accordance with an embodiment of the invention. Although the reactor 10 in this exemplary embodiment is cylindrically shaped, the invention is not so limited. The reactor 10 is an aggregate composition containing one or more reactants 12 and a gelling agent 14. Although the reactants 12 and the gelling agent 14 are shown only for a solvent interface 16 of the reactor 10, they are preferably present throughout the reactor 10. The gelling agent 14 forms a colloidal gel when it comes in contact with the main solvent. Thus, when the reactor 10 is placed in contact with the main solvent, the binder material in the parts of the reactor 10 that come in contact with the main solvent will form walls of colloidal gel that divide the wet parts of the reactor 10 into multiple reactor chambers. The colloidal gel allows some permeation of the main solvent and other fluids across it, but in a restricted manner. Although only one interface 16 is shown in this example for simplicity of illustration, there may be multiple interfaces between the reactor 10 and the main solvent; in fact, the reactor 10 may be placed in a bulk body of main solvent.

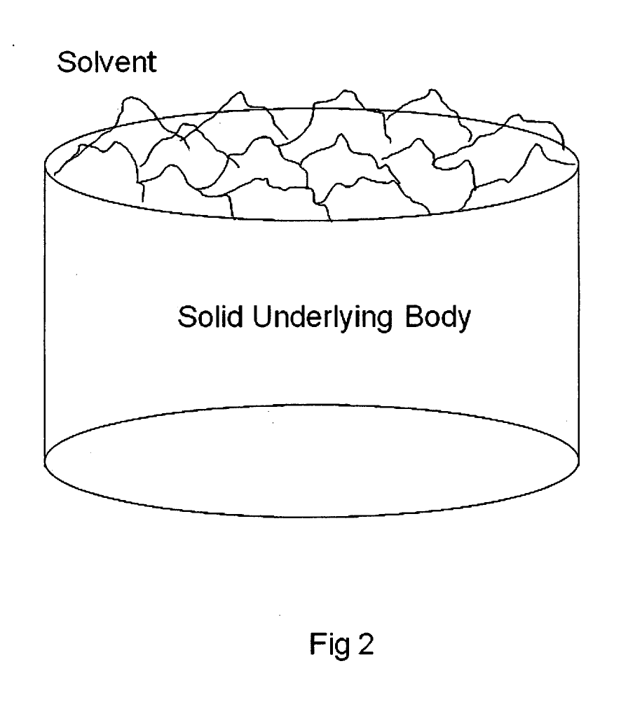

FIG. 2 is the reactor 10 after the solvent interface 16 has been exposed to the main solvent. As shown, colloidal gel 18 is formed at the interface between the main solvent and the reactor 10. The colloidal gel 18, which forms reaction chambers at the interface 16, restricts the diffusion of fluids across it. Thus, the environment inside of the reaction chambers is different from the bulk main solvent body outside the reactor 10. The environment inside the reactor 10 is more conducive to efficient target product generation than the bulk main solvent environment. While the colloidal gel walls form in parts of the reactor 10 that is in contact with the main solvent, the dry parts of the reactor 10 retain their original form.

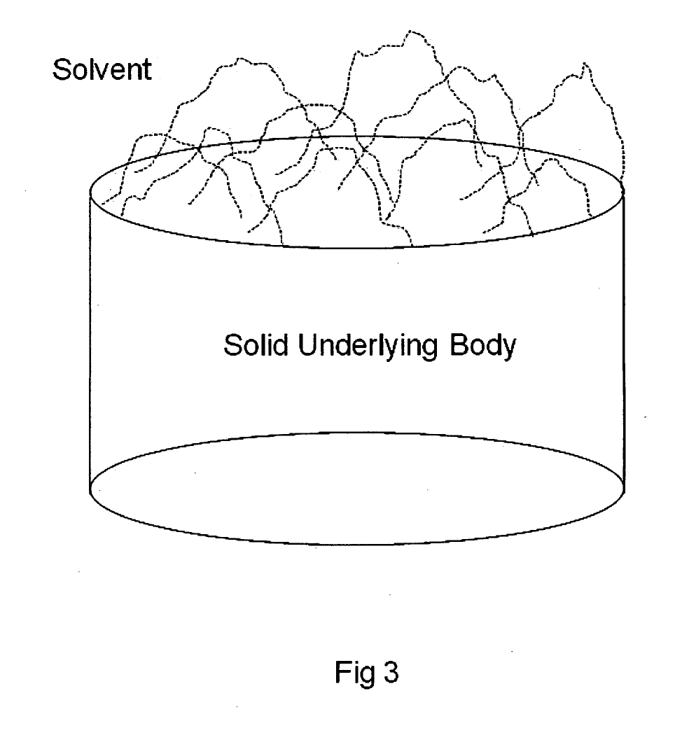

FIG. 3 is the reactor 10 after the reactant concentrations inside the activated reaction chambers have reached the depletion level. When the depletion level is reached, the colloidal gel walls 18 that form the reaction chambers begin to disintegrate, as shown with dotted lines to indicate the disappearance of the colloidal gel. The target product that was produced in the reaction chambers are released when the colloidal gel walls 18 disintegrate.

Since the colloidal gel walls prevent the main solvent from contacting the deeper portions of the reactor 10, the reactants 12 and the gelling agent 14 underneath the interface 16 remain substantially dry while the first layer of colloidal gel reaction chambers are generating the target product. The disintegration of the colloidal gel walls 18, however, causes the layer of reactants and binder mixture that was under the colloidal gel layer to come in contact with the main solvent. This newly exposed part of the reactor 10 then contacts the main solvent, forms another set of colloidal gel walls, generates the target product, and releases the target product. The next level of reactants-and-gelling agent then comes in contact with the main solvent, and the generation and release of the target product continues as layers of the reactor 10 are “dissolved away” into the main solvent body.

The invention includes a method of preparing the reactor. The reactor produces high concentrations of one or more target products that are different from the reactants that are initially present in the reactor. The method of the invention allows the production of compositions that are stable for storage and, upon activation by contact with the solvent, produce a target product in a high yield. There are a few different methods for making the reactor 10 of the invention, and some of the different methods produce different embodiments.

One of the methods for preparing the reactor 10 entails mixing the reactants with gelling agent and/or fillers and feeding the mixture to an agglomerating equipment. Once fed to the agglomerating equipment, a force of about 1,000 to about 10,000 pounds is applied. The pressure makes the gelling agent-reactant mixture agglomerate. The exact force to be applied is determined based on the final composition, the desired density of the resulting agglomerate, the desired dissolution rates, and the like. If desired, the agglomerate may be ground or crushed to achieve the desired particle size. The type and the amount of binders and/or fillers that is used depends on the desired size of the reactor and the oxidizing power. For example, a reactor having a lot of filler will have a weaker oxidizing power than a reactor of comparable size that is constituted mostly of reactants.

In an alternative method, the reactants are first mixed to form an agglomerate. There are various different ways to form the agglomerate. For example, a spray tower that is commonly used to agglomerate detergents, etc. may be used. This agglomerate can then be mixed with gelling agent and/or fillers to be agglomerated (for the second time) into a tablet, etc. This way, the reactants are already agglomerated and the gelling agent surrounds the reactants the reactants to form reaction chambers. In another example where the reactants, and gelling agent, and/or the filler are all combined at once, the reactants may be separated and need to migrate before a reaction can take place.

The agglomerate of reactants (with or without binders) is granulated or crushed to form small pieces, or granules, containing the reactant mixture. If the agglomerate already has a gelling agent layer surrounding them, the gelling agent layer may be broken during the granulation/crushing process. However, the granules are again combined with the gelling agent material to form a reactant-gelling agent mixture, and a force between about 1,000 to about 10,000 foot-pounds is applied to the mixture to form the agglomerate composition.

Examples of equipment suitable for producing the agglomerate composition in the above methods include a compactor, an agglomerator, a roll compaction, a briquetting/tableting tool, an extruder, and the like. These suitable equipment is obtainable from Hosokawa Micron Corporation.

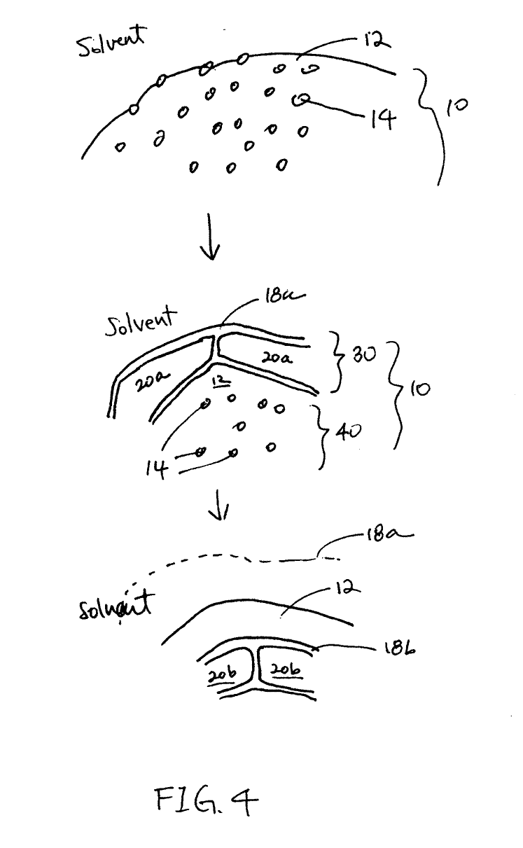

FIG. 4 shows the changes at the solvent interface 16 for a first embodiment. This first embodiment may be prepared by mixing the gelling agent and the reactants before forming an agglomeration. As shown, a reactor 10 containing the reactants 12 and the gelling agent 14 in an agglomerated form are initially placed in contact with the main solvent. As the gelling agent 14 absorbs the solvent and swells up, first colloidal gel walls 18a form, creating first reaction chambers 20a. The reactants 12 usually include an oxidizer reactant, an oxidizable reactant, or both. The first colloidal gel walls 18a allows fluid permeation but in a restricted manner. Thus, while the reactants 12 dissolve in the permeated solvent and chemical reactions are generating the target product in the first chambers 20a, a section 40 of the reactor 10 retains its dry form. The target product that is generated in the first reaction chambers 20a leave the reaction chambers 20a at a controlled rate. Once the depletion level is reached, the colloidal gel walls 18a disintegrate and disappear, as shown by the dotted lines in FIG. 4. The disintegration of the colloidal gel walls 18a exposes a new part of the reactor 10 to the main solvent. If some of the reactants 12 are directly exposed to the solvent, they will dissolve and react to generate the target product, but this chemical reaction will not have a yield as high as if it had occurred under the sheltered environment of the colloidal gel reaction chambers. The gelling agent 14 absorbs the main solvent and forms a colloidal gel wall 18b, forming another set of reaction chambers 20b. Once the colloidal gel walls 18b are formed, the main solvent permeates into the reaction chamber 20b in a controlled manner. The reactants 12 in the chamber, activated by this main solvent, generate the target product and the target product is released at a controlled rate. When the depletion level is reached, the colloidal gel wall 18b disintegrates (not shown) and releases the generated target product into the bulk solvent body. Since only a portion of the reactor 10 generates the target product at a given time, a gradual time-release of the target product is achieved.

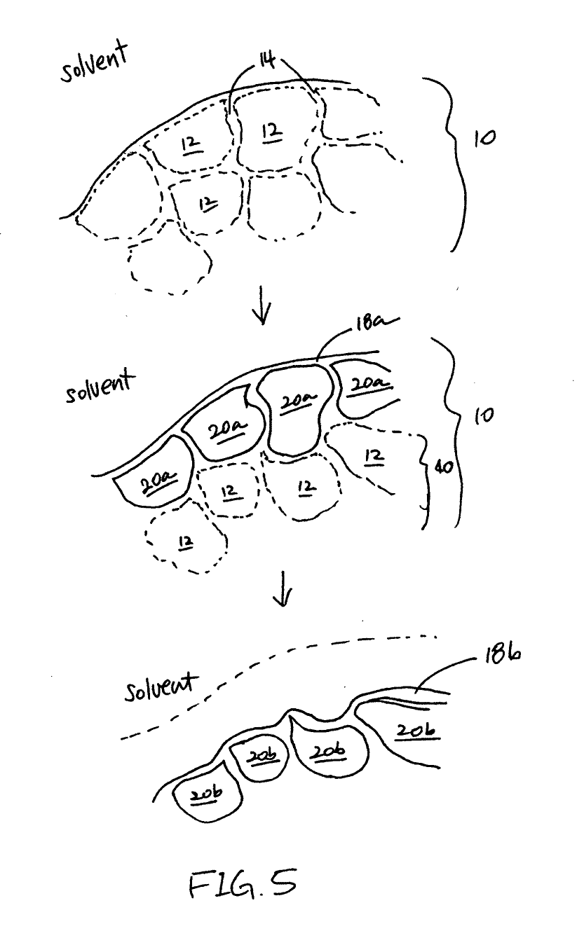

FIG. 5 shows the changes at the solvent interface 16 for a second embodiment. This second embodiment may be prepared by forming granules of reactants, coating and/or mixing the granules with gelling agent, and applying pressure to agglomerate the gelling agent-coated granules. As shown in FIG. 5, the outlines of the pre-agglomeration granules can be seen, defined by the gelling agent 14. When the reactor 10 is placed in contact with the solvent, colloidal gel walls 18a form near the outer areas of the reactor 10 where the binder material absorbs the solvent. The formation of the colloidal gel walls 18a creates first chambers 20a while the section 40 of the reactor 10 maintains its original form. The solvent continues to permeate through the colloidal gel walls 18a, dissolving the reactants 12 in the chambers 20a and triggering a chemical reaction that generates the target product. The target product permeates out of the chambers 20a, preferably in a solution form. Eventually, the first chambers 20a reach the depletion level and disintegrate, as shown by the broken line indicating the original outline of the reactor 10. When the first chambers 20a disintegrate, the solvent comes in contact with the next layer of reactants and gelling agent, and forms a second colloidal gel wall 18b. The second colloidal gel wall 18b forms a set of second chambers 20b, which then generate the target product.

Although the figures only show the reactants 12 and the gelling agent 14, there may be additional layers deposited on the reactor as indicated herein. For example, a protective coating layer such as one that contains a polymer, polysaccharide, polyvinyl alcohol, silicate or fumed silica may be deposited on the outer surface of the reactor 10 to shield the reactor 10 from moisture, etc. during storage. Other components such as pH buffer and filler may also be used as desired, and they are described in detail below.

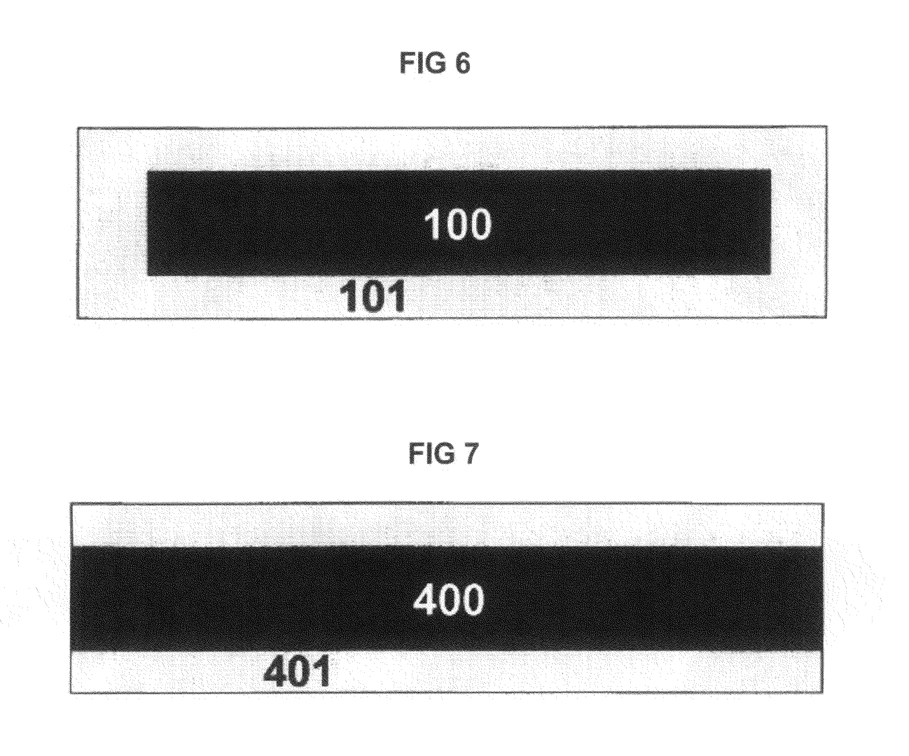

FIG. 6 shows the in-situ generating portion 100 encapsulated by the free halogen donor 101.

FIG. 7 shows the in-situ generating portion 400 sandwiched between two layers of at least one free halogen donor 401.

### Gelling Agent

Gelling agents are combined with the reactants to form a mixture. Gelling agents, upon exposure to the main solvent, form a colloidal gel that is permeable to the main solvent. Examples of gelling agents include polysaccharides including cellulose, chitosan and chitin, absorbent polyacrylic polymers and copolymers such as Carbopol®. A poloxamer block copolymer such as Poloxamer 407 sold by BASF under the trade name Lutrol® F127, polyvinyl alcohol with or without borax, or polyacrylamides may also be used. Gelling agents can be a stand-alone polymer as illustrated or a combination of components that may include a stiffening agent that cross-links with the polymer and increase viscosity and/or pH buffers that adjust the pH to achieve the desired viscosity.

Silicates make effective binders for holding the reactants in place and restricting the release of reactants until the desired oxidant is produced. Silicate-based coating material may be something that contains silicate, such as metasilicate, borosilicate, and alkyl silicate. Under low-pH conditions, the silicates remain colloidal; however, when the acid-catalyzed conditions induced by the reactants is depleted, the colloid dissipates. Upon dissipating, various polysaccharides such as cellulose and chitosan form permeable gel barriers that can effectively function as reactor walls. Certain polymers such as water absorbent polyacrylates and their copolymers can also form gels. One example is Carbopol® sold by Noveon, Inc. located in Cleveland, Ohio.

### B. Gelatinous Structure

A tablet may be prepared with a gel-forming material that forms a gelatinous structure when exposed to the main solvent. When the gelatinous structure is formed, so do chambers as described above. The chambers contain reactants that produce the target product from an in-situ chemical reaction, allowing for substantially higher yields of product than tablets having equivalent mass with no gel-forming additive. The gelatinous structure may disintegrate and dissipate after the chamber contents are depleted.

Using the gelatinous structure of the invention, water-soluble compositions for generating chlorine dioxide can be produced that yield concentrations of chlorine dioxide over 250% more than the existing water-soluble compositions. Further still, the disclosed invention increases the weight yield of chlorine dioxide by over 30% above the existing compositions that are made of or produce water-insoluble constituents. Water-soluble gels provide superior improvement over the existing compositions that utilize high concentrations of inert materials (e.g., swelling clays) to construct a porous structure.

Gel forming additive technology can be readily assimilated into other in-situ generating tablets to achieve the same benefits in yield by increasing the weight % of reactants in the agglomerate composition, and resulting in an increase in the weight % yield of desired product.

The invention is based on the use of substantially low levels of gel-forming material that bind and hold the reactants together while immersed in the main solvent, thereby maintaining the structural integrity of the agglomerate composition. The gel, which is formed when the gel-forming material contacts the main solvent, restricts the diffusion of the reactants until the reaction is near complete. After the reaction is substantially complete, the gel disintegrates. The gel-forming material may be a polymer or copolymer that increases solution viscosity, and at least one component that enhances gel formation and rigidity.

The gel-forming materials are particularly useful in producing self-sustaining tablets that produce high yields of in-situ generated oxidants. The use of this gel-forming technology dramatically reduces the quantity of inert materials used to improve reaction kinetics in prior art, and substantially increases the “weight % yield” of the tablet when compared to tablets incorporating currently known methods.

Without limiting the invention, useful components used in forming water-soluble gels include: polymers such as PVA or cross-linked polyacrylates sold under the trade name Carbopol® by Novean, and copolymers such as polyoxyethylene polyoxypropylene block copolymer sold under the trade name Lutrol® by BASF, polysaccharides, pH buffers such as alkali or acids, and coagulating agents such as sodium aluminate.

Composite gels are particularly useful in that small quantities relative to the total mass of the agglomerate composition dramatically improve the structural integrity of the agglomerate when immersed in water, and improve the weight % yield of the agglomerate composition. Composite gels contain at least two additives that, when combined, produce a gelatinous structure having a viscosity substantially higher than that obtained using either the additive alone when exposed to the same pH conditions. Composite gels are produced by combining a viscosity-increasing material with an additive that enhances the formation and rigidity of the gel. For example, a composite gel may be a combination of PVA and borax. When composite gelling agents are used, the number and types of compounds that can be used increases. Also, the amount of viscosity modifying agent can often be substantially decreased.

For example, while PVA increases the viscosity of the solution, it does not form an effective gel alone. Elvanol® sold by DuPont typically shows a viscosity profile of up to approximately 2,000 centipoise at a 10 wt. % solution. However, combining borax or boric acid with an alkali and the PVA produces a gelatinous composite having a viscosity over 100,000 centipoise. Composites can also be produced by combining multiple gel-forming materials to produce a gel of substantially higher viscosity than when the compounds are used with pH buffers as illustrated in the examples.

### Gelatinous Structure

In the gelatinous structure capable of producing in-situ generated oxidants in high yield, the viscosity of the gel is sufficiently high to prevent diffusion of the reactants and gel even under conditions that would normally induce rapid dilution. The viscosity being sufficiently high also helps maintain the structural integrity of the agglomerate as to prevent a premature breakup of the agglomerate composition when immersed in excess diluting solvent. The gel rigidity is preferably at a level that is sufficient to prevent rapid dispersion of the agglomerate even when agitation or circulation of the water occurs. To achieve this, it is desirable to utilize a gel-forming chemistry that produces a “gelatinous structure” within the agglomerate. This gelatinous structure has a viscosity greater than about 5,000 centipose, preferably greater than about 50,000 centipoise, and preferably greater than about 100,000 centipoise. It is desirable that the rheology within the high viscosity gel-structure have pseudoplastic characteristics, such that upon shaking or jarring, the agglomerate does not break up as would be expected if the gel-structure possessed the behavior of a thixotropic material. As the outer layers of agglomerate react and dissipate, the gelatinous structure will experience increased dispersion, the viscosity will decrease with time and dilution, and the gel-structure may take on thixotropic characteristics.

The gelling agent constitutes no more than 10 wt. % of the gelatinous structure, preferably constitutes less than about 5 wt. % of the gelatinous structure.

### Applying the Gelling Agent

The gelling agent can be mixed with the other components prior to forming a tablet or agglomerate. A ribbon mixer, tumbler or any commercially viable means of applying the coating to the reactant(s) can be used.

In another application, the gelling agent can be applied to the surface of the reactant(s) having the higher solubility thereby forming a coating, followed by mixing the coated reactant(s) with the other component(s) that have lower solubility. The coating may be applied by simply mixing the gelling agent and reactant together, or by physically attaching the gelling agent to the surface of the reactant by using methods such as Magnetically Assisted Impact Coating (MAIC).

In yet another application, the gelling agent is applied to the surface of at least the chlorite donor by spraying a solution of the gelling agent onto a surface of the chlorite donor in a fluid bed coating system followed by drying. A suitable method is exemplified by the Wurster process wherein the solid chlorite donor is suspended in a stream of heated air and a solution of gelling agent is sprayed onto the surface of the chlorite donor where it is then dried in the stream of air thereby encapsulating the chlorite donor.

### Example 1

0.6 grams of sodium metasilicate is dissolved in 100 mL water. Acid is added to reduce the pH to 6.5, at which point a colloidal silicate forms. The viscosity of the solution remains sufficiently low such that the solution is readily pourable.

### Example 2

0.6 grams Carbopol® is combined with 100 mL of water and dispersed, followed by pH increase with NaOH to achieve the gel point. The viscosity is high but the gel remains pourable.

### Example 3

0.4 grams Carbopol® was combined with 0.2 grams of ground sodium metasilicate. The mixture was sprinkled into 100 mL of vigorously mixed water while measuring pH. Once added, the pH increased to approximately 10.5, then quickly but steadily dropped until a final pH of 6.5 was achieved. After approximately four minutes, the viscosity exceeded the magnetic stirrer capacity to agitate the gel. After six minutes, the clear gel produced was un-pourable and remained in the beaker while the beaker was inverted.

The gel produced from the Carbopol®-silicate composite was substantially higher in viscosity and substantially more rigid than that produced by either equivalent weights of silicate or Carbopol® alone.

At the pH range of approximately 4-7, the water-soluble silicate is converted to a colloidal suspension, and the Carbopol® viscosity increases. Combined, it is theorized that the colloidal silicate, when intimately dispersed in the polymer gel, further stiffens the gel as the gelatinous structure forms by producing a three-dimensional structure of interlacing particles or solvated macromolecules that restrict the movement of the dispersing medium.

Other additives such as sodium aluminate or higher concentrations of alkali salts can replace the water-soluble silicate in the composite. Once adequately diluted, the gel components dissipate and/or completely dissolve in the water.

When the gel-forming material is intimately mixed with the reactants making up the composition, it is expected that the reactants themselves induce the formation of a two-phase system until such time the reactants completely dissociate and react to produce the desired product. When the dissociated reactants produce the desired product, it is expected that the gel-structure will alter its rheology and take on more pseudoplastic (single-phase) properties.

### Adding the Gelling Agent

The gelling agent is effectively dispersed or distributed within the agglomerate to be effective. If the gelling agent is added to the dispersing medium (water) in a haphazard manner, there is a tendency for the agent to “clump.” The outer molecules of the gelling agent contact the medium first and hydrate, forming a surface layer that is more difficult for the medium to penetrate. The clumps will ultimately hydrate but it will take more time. It is therefore preferable to distribute the gelling agent with the reactants prior to producing the final agglomerate (tablet). The gelling agent can be applied to the mixture of reactants prior to agglomeration, or in the case of granulation, after granulation prior to agglomeration. In an alternative method, the gelling agent can be applied to both the powdered mixture and the granules.

It is also beneficial to have additional additives that enhance the formation of the gel and/or increase the rigidity of the gel in intimate contact with the gel-forming material when the solvent begins hydrolyzing the gel-forming material. To do this, the additives, such as those used in forming composite gels, are effectively combined with the gel-forming agent, and are considered to be included with the gelling agent as described above. In the case of pH modifiers that induce gel formation as in the case of synthetic polymers such as Carbopol® the pH modifier can be combined with the Carbopol®, provided by the reactant composition, or be naturally provided with the water, such as natural acquiring alkalinity.

This technology has great utility in slowing the release of traditional oxidizers such as: calcium hypochlorite, trichloroisocyanuric acid, dichloroisocyanuric acid, lithium hypochlorite, dibromodimethylhydantoin, bromochlorodimethylhydantoin, percarbonate, perborate, monopersulfate, persulfate and the like where large volumes of dilution water are present, and controlled release is desired such as in cooling towers, swimming pools, toilets and the like.

None of the prior art discloses a self-sustaining tablet comprised of reactants for in-situ generation of an oxidant combined with a gel-forming material that forms a gelatinous structure and increases the yield of the oxidizer product. The advantages over the prior art are: higher concentrations of reactants in the composition, increased “weight % yield” of oxidants, elimination of reaction containers such as those disclosed in one of the Wei patents, extended release times of in-situ generated oxidants compared to agglomerate compositions not including the gelling agent, greater stability which allows bulk packaging, and controlled release that allows use in multi-tablet chemical dispensers.

The reactor has far-reaching applications. Reactants such as PMPS and NaCl are quite stable when dry but once moisture is added and reactions are triggered, an agent with a completely different set of properties may be produced. The reactor allows for a stable point-of-use product with easy application. The fact that the reaction is triggered by moisture allows for a wide range of applications since the reactor remains stable until some type of liquid, such as water, contacts the composition. The contaminated liquid that is to be treated is what activates the reactor to generate and release target products for treatment. When the released target products are oxidizers, they treat the bulk liquid by controlling bacteria, viruses and various organic and inorganic contaminants.

The benefits of the invention are broad in nature. The “reactors” formed by the gelatinous structure are stable for storage and provide safe bleaching agents and antimicrobial agents in a form that is ready for use. This technology enhances the utility of the agents. For example, the agents can be combined with traditional pool water treatments to provide chlorine dioxide or hydroxyl radicals for a synergistic effect.

One benefit of the invention is to control the reactor chemistry as to maximize the concentration of reactants in an environment conducive to forming the target products. For example, N-chlorosuccinimide generation is best performed under acidic conditions where chlorine gas and/or hypochlorous acid are readily available. In applications such as laundry bleaching, generation of N-chlorosuccinimide is less than optimal because the alkaline pH (generally >9.0) is not well suited for producing N-chlorosuccinimide. By producing N-chlorosuccinimide in a contained space inside the reactor and controlling the diffusion rate of product and reactants out of the reactor, the conditions that are conducive to high conversion rates and yields are sustained. Thus, the yield is maximized prior to the product's being releasing into the alkaline bleaching environment of the wash-water. Similar characteristics are true of the various oxidizers produced by reacting reagents to generate more powerful oxidants in-situ. Conditions such as pH, concentrations of reactants, and minimizing oxidizer demand such as that found in the bulk wash-water must be controlled to maximize conversion of the reactants and the yield of the target product.

The reactor 10 can be formed into any useful size and shape, including but not limited to a granule, nugget, wafer, disc, briquette, or puck. While the reactor is generally small in size (which is why it is also referred to as the micro-reactor), it is not limited to any size range.

### Data

A composition comprised of 30% dichloroisocyanuric acid, 30% sodium bisulfate, and 37.5% sodium chlorite combined with 2.5% PVA was thoroughly mixed and pressed to produce granules. The composition of these granules is referred to as “the 334 composition”. The >200 but <300 split of granules was used for the following test.

Tests were conducted using varying wt. % of gel-forming material that contains 67 wt. % Carbopol® 676 and 33 wt. % ground sodium metasilicate. The gel-forming material was admixed with the granules, and the final composition was pressed into a tablet. All tablets were of the same shape, and were relatively equal in size as disclosed in the tablet.

One sample of granules was ground to produce a powder, and the powder was then pressed into a tablet with no gel-forming material.

### Test Rig

A 5-gallon container was equipped with a mixer fixed in position and centered in the middle of the container, and a pH probe attached to a digital readout was immersed below the water line. A spectrophotometer calibrated for chlorine dioxide at 445 nm wavelength was set to read continually, and was zeroed before each run.

When the tablet was immersed and released into the container, the turbulence from the mixer was such that it continually swirled the tablet in approximately a 6-inch diameter circle, thereby preventing settling which can cause localized accumulation of reactants and pH that could skew the results in favor of increased chlorine dioxide yield.

A sample cell was immersed into the swirling solution at time increments noted in the table. A stop watch tracked lapsed time, and the pH was noted. The sample cell was wiped dry, placed in the photometer, and the results noted, whereby the sample was returned to the container.

### Test Results

The tests show how the composition significantly influences the production of chlorine dioxide. The sample made with powder produced from the same composition as the granules used to make the other tablets produced 30% less chlorthe dioxide than the tablet made from the granules.

When the gel-forming material was added to the tablets, a significant increase in Weight % Yield resulted. By adding just 1 wt. % of the gel-forming mixture to the granules prior to agglomerating into a tablet, there was a 78.5% increase in weight % yield over the tablet made from powder, and a 39% increase over the tablet made from granules without the gel-forming material.

As indicated by the tables below, the tablet produced from the 2.5% and the 5 wt. % gel-forming material retained its integrity as a tablet for an extended period of time and did not produce the peak in chlorine dioxide concentration as observed in the other samples. However, the tablet sustained the output for an extended period of time. This could prove very useful in applications where it is desirable to release the in-situ generated oxidizer over an extended period of time while immersed in water, rather than a rapid spike followed by a slow decay in concentration. Examples include cooling tower treatments, potable water treatment, toilet bowl immersed tablets, etc.

| | Weight | Water volume | mg/ltr | weight % |
|---|---|---|---|---|
| Sample | (gm) | (ltr) | produced | Yield |
| No Gel - Powder | 2.9 | 10.5 | 28 | 10.14 |
| No Gel - granules | 2.9 | 10.5 | 36 | 13.03 |
| 0.5% Gel - | 2.2 | 10.5 | 30 | 14.32 |
| Granules | | | | |
| 1.0% Gel - | 3.0 | 10.5 | 50 | 18.10 |
| Granules | | | | |

| | | No Gel | |
|---|---|---|---|
| Start Temp (F.) | | 82 | |
| Start pH | | 7.89 | |
| Finish pH | | 7.1 | |
| Weight (gm) | | 2.9 | |
| Volume (liters) | | 10.5 | |
| Speed setting (1-5) | | 1 | |
| | Lapsed | | |
| | Time | PPM | pH |
| | 0:00 | 0 | 7.89 |
| | 0:45 | 30 | 7.10 |
| | 1:30 | 36 | 7.04 |
| | 2:30 | 35 | 7.07 |
| | | 0.5% | |
| | | Gel | |
| Start Temp (F.) | | 83 | |
| Start pH | | 7.89 | |
| Finish pH | | 7.21 | |
| Weight (gm) | | 2.2 | |
| Volume (liters) | | 10.5 | |
| Speed setting (1-5) | | 1 | |
| | Lapsed | | |
| | Time | PPM | pH |
| | 0:00 | 0 | 7.88 |
| | 0:45 | 26 | 7.18 |
| | 1:30 | 30 | 7.18 |
| | 2:30 | 29 | 7.21 |
| | | 1.0% | |
| | | Gel | |
| Start Temp (F.) | | 83 | |
| Start pH | | 7.89 | |
| Finish pH | | 7.12 | |
| Weight (gm) | | 3.0 | |
| Volume (liters) | | 10.5 | |
| Speed setting (1-5) | | 1 | |
| | Lapsed | | |
| | Time | PPM | pH |
| | 0:00 | 0 | 7.89 |
| | 0:45 | 13 | 7.57 |
| | 1:30 | 38 | 7.05 |
| | 2:30 | 47 | 7.04 |
| | 3:30 | 50 | 7.07 |
| | 4:30 | 49 | 7.12 |
| | | 2.5% | |
| | | Gel | |
| Start Temp (F.) | | 83 | |
| Start pH | | 7.89 | |
| Finish pH | | 7.15 | |
| Weight (gm) | | 2.9 | |
| Volume (liters) | | 10.5 | |
| Speed setting (1-5) | | 1 | |
| | Lapsed | | |
| | Time | PPM | pH |
| | 0:00 | 0 | 7.89 |
| | 0:45 | 7 | 7.7 |
| | 1:30 | 14 | 7.41 |
| | 2:30 | 21 | 7.27 |
| | 3:30 | 25 | 7.23 |
| | 4:30 | 26 | 7.21 |
| | 5:30 | 26 | 7.21 |
| | 7:30 | 24 | 7.22 |
| | 9:30 | 24 | 7.15 |
| | | No | |
| | | Carb | |
| | | Powder | |
| Start Temp (F.) | | 82 | |
| Start pH | | 7.89 | |
| Finish pH | | 7.1 | |
| Weight (gm) | | 2.9 | |
| Volume (liters) | | 10.5 | |
| Speed setting (1-5) | | 1 | |
| | Lapsed | | |
| | Time | PPM | pH |
| | 0:00 | 0 | 7.89 |
| | 0:45 | 26 | 7.06 |
| | 1:30 | 28 | 7.04 |
| | 2:30 | 27 | 7.07 |

| | | 5% C/S + | |
|---|---|---|---|
| | | 200 | |
| Start Temp (F.) | | 82 | |
| Start pH | | 7.85 | |
| Finish pH | | | |
| Weight (gm) | | 3.0 | |
| Volume (liters) | | 10.5 | |
| Speed setting (1-5) | | 1 | |
| | Lapsed | | |
| | Time | PPM | pH |
| | 0:45 | 2 | 7.73 |
| | 1:30 | 6 | 7.65 |
| | 2:30 | 10 | 7.56 |
| | 3:30 | 14 | 7.51 |
| | 4:30 | 15 | 7.50 |
| | 5:30 | 14 | 7.48 |
| | 6:30 | 14 | 7.48 |
| | 7:30 | 16 | 7.49 |
| | 8:30 | 16 | 7.50 |
| | 9:30 | 16 | 7.52 |
| | 10:30 | 18 | 7.54 |
| | 11:30 | 16 | 7.55 |
| | 12:30 | 16 | 7.57 |
| | 13:30 | 15 | 7.58 |
| | 14:30 | 14 | 7.59 |
| | 15:30 | 14 | 7.62 |
| | 21:30 | 12 | 7.72 |
| | 22:30 | 13 | 7.74 |
| | 26.30 | 12 | 7.79 |
| | 28.30 | 11 | 7.82 |

In a similar test, the 334 composition disclosed above was used to produce Tablets of approximately 4.0 grams in size. A control sample was produced and contained no additives. The remaining tablets were produced to include additives at 1 wt. % to compare performance profiles of individual additives as well as combinations. One tablet was produced by first forming granules from the 334 composition, then admixing 1 wt. % of the Carbopol®/silicate (“C/S”) gelling agent, then the combined mixture was pressed into a tablet. Each approximate 4.0 gram tablet was added to 14 L of water with sufficient agitation as to prevent settling of the tablet while continually monitoring the pH.

### TESTING Round 2:

| | | 1% | | | | |
|---|---|---|---|---|---|---|
| | | CaStearate | | | 1% Carb | |
| Start Temp (F.) | | 82 | | | 82 | |
| Start pH | | 7.85 | | | 7.85 | |
| Weight (gm) | | 4 | | | 3.9 | |
| Volume (liters) | | 14 | | | 14 | |
| Speed setting | | 1 | | | 1 | |
| (1-5) | | | | | | |
| | Lapsed | | | Lapsed | | |
| | Time | PPM | pH | Time | PPM | pH |
| | 0:45 | 36 | 7.45 | 0:45 | 20 | 7.53 |
| | 1:30 | 45 | 7.29 | 1:30 | 41 | 7.35 |
| | 2:30 | 44 | 7.30 | 2:30 | 44 | 7.30 |
| | 3:30 | 44 | 7.32 | 3:30 | 41 | 7.32 |
| | | | | 4:30 | 41 | 7.34 |
| | | | | | 1% C/S | |
| | | 1% Luwax | | | grnl | |
| Start Temp (F.) | | 81 | | | 82 | |
| Start pH | | 7.85 | | | 7.85 | |
| Weight (gm) | | 3.9 | | | 4 | |
| Volume (liters) | | 14 | | | 14 | |
| Speed setting | | 1 | | | 1 | |
| (1-5) | | | | | | |
| | Lapsed | | | Lapsed | | |
| | Time | PPM | pH | Time | PPM | pH |
| | 0:45 | 30 | 7.57 | 0:45 | 15 | 7.48 |
| | 1:30 | 47 | 7.05 | 1:30 | 32 | 7.30 |
| | 2:30 | 49 | 7.04 | 2:30 | 35 | 7.32 |
| | 3:30 | 47 | 7.07 | 3.30 | 32 | 7.35 |
| | | | | 4:30 | 31 | 7.39 |
| | | | | 5:30 | 34 | 7.43 |
| | | 1% C/S | | | Control | |
| Start Temp (F.) | | 84 | | | 82 | |
| Start pH | | 7.85 | | | 8.01 | |
| Weight (gm) | | 3.9 | | | 4.0 | |
| Volume (liters) | | 14 | | | 14 | |
| Speed setting | | 1 | | | 1 | |
| (1-5) | | | | | | |
| | Lapsed | | | Lapsed | | |
| | Time | PPM | pH | Time | PPM | pH |
| | | | | 0:00 | 0 | 8.01 |
| | | | | 0:45 | 18 | 7.64 |
| | 0:45 | 32 | 7.22 | 1:30 | 36 | 7.43 |
| | 1:30 | 60 | 7.23 | 2:30 | 35 | 7.43 |
| | 2:30 | 61 | 7.27 | 3:30 | 33 | 7.44 |
| | 3:30 | 60 | 7.31 | 4:30 | 32 | 7.45 |
| | 4:30 | 59 | 7.34 | 5:30 | 29 | 7.47 |
| | | | | 6:30 | 30 | 7.50 |
| | | | | 7:30 | 29 | 7.52 |
| | | | | 8:30 | 26 | 7.54 |
| | | | | 9:30 | 24 | 7.57 |
| | | | | 10:30 | 23 | 7.59 |
| | | | | 11:30 | 23 | 7.61 |
| | | | | 12:30 | 23 | 7.63 |
| | | | | 13:30 | 20 | 7.66 |
| | | | | 14:30 | 19 | 7.69 |
| | | | | 15:30 | 18 | 7.71 |
| | | | | 16:30 | 17 | 7.73 |
| | | | | 29.3 | 8 | 7.99 |
| | | 1% | | | | |
| | | Silicate | | | | |
| Start Temp (F.) | | 83 | | | | |
| Start pH | | 7.85 | | | | |
| Weight (gm) | | 4.0 | | | | |
| Volume (liters) | | 14 | | | | |
| Speed setting | | 1 | | | | |
| (1-5) | | | | | | |
| | Lapsed | | | | | |
| | Time | PPM | pH | | | |
| | 0:45 | 25 | 7.58 | | | |
| | 1:30 | 37 | 7.40 | | | |
| | 2:30 | 33 | 7.41 | | | |
| | 3:30 | 32 | 7.44 | | | |
| | 4:30 | 31 | 7.47 | | | |

This set of data illustrates that as the concentration of polymer increases in relation to the surface area of the reactant composition, the sustainability of the in-situ generated oxidant release increases. By incorporating a stiffening agent with the polymer, lower levels of polymer can be employed while dramatically increasing the Weight % Yield. In the case of adding 1 wt. % Carbopol®/Metasilicate mixture to the powdered reactants prior to agglomerating, the “weight % Yield” increased to over 21% of the total mass of tablet.

This synergistic effect is very useful in restricting the diffusion of the reactants, thereby sustaining a high concentration of reactants until the reactions are near completion without the need for additional coatings, binders, or containers. One benefit is the ability to formulate compositions using high concentrations of reactants without the need for including inert materials to provide porosity or heat to improve reaction kinetics. As a result of utilizing this invention, higher concentrations of reactants can be incorporated into the tablet, and a higher “weight % yield” is achieved than that obtained using prior art methods. The agglomerates produced are also self-sustaining in that they do not require additional containers such as membranes, paper wrappings etc. to effectively function in an environment that induces rapid dilution of the reactants.

As a result of these findings, it is possible to produce agglomerates for a variety of in-situ generated oxidants that can produce high “Weight % Yield” of the desired oxidants independent of secondary coatings, housings, or containment. Further still, the data clearly illustrated that water-soluble compositions for in-situ generation of chlorine dioxide can be produced that provide an increase in “Weight % Yield” of 300% higher than water soluble agglomerate compositions disclosed in the prior art “404”. Further still, the compositions of the disclosed invention increase the Weight % Yield of chlorine dioxide over any disclosed compositions of “404” even water-insoluble compositions, by as much 43%. The compositions of the invention can be designed to provide rapid release of oxidant at higher yield, or maintain a sustained release of extended periods.

C. Biocidal Composition using Synergistic Effect of Chlorine Dioxide and Halogen

The biocide compositions of the invention includes a composition for the in-situ generation of an oxidizer and a free halogen donor. Although the examples herein focus on chlorine dioxide as an exemplary oxidizer, the synergistic effect may be achieved with oxidizers other than chlorine dioxide, such as the target products mentioned above.

There are many configurations that use gelling agents to generate the chlorine dioxide. For utility in applications such as industrial cooling tower treatment where the biocide tablets may be incorporated into an enclosed dispenser, the release rate of the chlorine dioxide may be controlled for optimization.

As described above, addition of a gel-forming material to high-solubility reactants such as dichloroisocyanuric acid, acid donors such as sodium bisulfate and other optional reactants that initiate reaction with chlorite to produce in-situ generated chlorine dioxide, dramatically increases the percent conversion of chlorite along with substantially increasing the weight % yield of the chlorine dioxide composition as a result of producing chambers having a gel-structure that restricts diffusion of the reactants into the solvent. It demonstrated above that a small 4-gram tablet could be made to sustain release of chlorine dioxide for over 30 hours, while untreated tablets of the same composition where completely dissolved in approximately 90 seconds. This same effect can be achieved with the high-solubility inorganic bromide salts to produce hypo-bromite containing solutions.

This capability not only increases the percent conversion and improves the weight % yield of the chlorine dioxide component of a composition, but also improves the safety of using such compositions by preventing rapid release of chlorine dioxide when feed systems fail or the tablets are exposed to a stagnant condition while immersed in water. Rapid or excessive release of chlorine dioxide could present significant hazards due to pressure buildup, explosion, and injury to personnel exposed to the vapors or catastrophic failure of the equipment. By combining the sustained release chlorine dioxide generating composition into a matrix of low-solubility free halogen donors, a safe and effective agglomerate results that provides biocidal efficacy better than the agents used alone.

The invention discloses various agglomerate biocidal compositions that provide multiple oxidizers which in turn provide a synergistic effect, and provide for the cost effective methods of producing the agglomerates. Another added benefit of the disclosed invention is that the appropriate composition can be selected based on the needs of the application. In highly stressed systems, a chlorine dioxide-bromine composition can be applied, whereas in lesser stressed systems, a chlorine dioxide-chlorine composition is suitable.

The agglomerates can be applied in the form of a granule or tablet of any convenient size and shape. Of significant advantage over conventional technologies is the ability to combine these oxidizers while achieving a high “weight % yield” of chlorine dioxide, and high % conversion of the chlorite without the addition of large quantities of inert salts and clays.

The compositions are comprised of granules capable of independently producing in-situ generated chlorine dioxide in high yield, as well as larger bodies comprised of a plurality of granules with additional halogen-based biocidal agents such as chlorine and/or bromine. Further still, an agglomerate comprised of several different layers or boundaries whereby the in-situ generating portion of the tablet is coated or layered between a free halogen donor, which may or may not include additional gel forming agent. In another form of the art, the bromine is also produced in-situ by reaction between chlorine donor and bromide ions alone with the chlorine dioxide, thereby maximizing chlorine dioxide and bromine generation, while releasing low levels of the less effective chlorine which is readily consumed in highly contaminated waters.

Tablets can be produced by combining trichloroisocyanuric acid and a chlorite donor. In another example, granules can be produced by combining dichloroisocyanuric acid, chlorite donor, and an acid source. The granules can be coated with a coating having a solubility substantially lower than that of the reactants, and/or incorporate a gel forming additive. These granules can be used independently as a biocidal agent, or admixed with additional halogen and formed into granules or tablets. In all examples, a gel-forming additive can be applied to further enhance the % conversion of chlorite to chlorine dioxide, as well as provide added safety for the practical use of the composition.

The compositions of the invention can be produced efficiently to provide a cost-effective and safe means of applying chlorine dioxide to recirculating water systems such as cooling water system, pools and spas. By combining oxidants as disclosed, effective biocidal performance can be achieved even in high demand applications where excess amount of bromine or continued regeneration of bromide ions is either not effective or economical. Combining a high yield chlorine dioxide technology with a bromine donor provides a synergistic effect, even when residual chlorine and/or bromine are converted to halogenated amine compounds. The elimination of expensive feed equipment and the difficulties in controlling and optimizing ratios are eliminated. Also, the compositions of the disclosed invention can be made to produce Class II oxidants or less as defined by the National Fire Protection Association so as to allow for increased storage and limited restrictions as pertaining to Department of Transportation regulations.

Also, due to the limited solubility of these compositions, the concentration of chlorine dioxide allowed to accumulate in a closed feed system will be limited based on the solubility characteristics of the specific composition. While it would be expected that due to the solubility of many of the disclosed reactants use to generate the chlorine dioxide, there exist a potential for higher concentrations of chlorine dioxide to accumulate in the system which loses flow of water and is allowed to sit stagnant in water. Addition of gel-forming agents such as Carbopol®, as well as a low solubility binding agents such as polyethylene wax (Luwax®), calcium stearate and the like, can dramatically slow the liberation of chlorine dioxide even without inclusion in the low solubility halogen matrix. As the solution reaches saturation, the rate of chlorine dioxide generation would taper off as to prevent excess pressure buildup inside the feeder from the continued or excessive generation of chlorine dioxide.

To further enhance the longevity of the chlorine dioxide in the circulating water, a non-ionic surfactant can be added to either the water or directly to the composition. A few examples of non-ionic surfactants include: polyoxyethylene alkyl ethers, polyoxyethylene alkylaryl ethers, polyethylene glycol fatty acid esters, and the like.

### Chlorine Dioxide Versus Chlorine

The use of gaseous chlorine as a microbiocide for industrial cooling systems is declining because of safety, environmental and community impact considerations. Various alternatives have been explored, including bleach, bleach with bromide, bromo-chlorodimethyl hydantoin (BCDMH), non-oxidizing biocides, ozone, and chlorine dioxide, among others. Chlorine dioxide offers some unique advantages, due to its selectivity, effectiveness over a wide pH range, and speed of kill. Safety and cost issues have restricted its use as a viable replacement.

The following “report card” compares the effectiveness of chlorine dioxide with other oxidizing biocides, and illustrates the superior performance of chlorine dioxide as a biocide:

COMPARISON OF OXIDIZING BIOCIDES IN LIGHT
OF THE CRITERIA OF AN “IDEAL” BIOCIDE
Report Card

| | | | |
|---|---|---|---|
| HOCl | HOBr | ClO₂ | O₃ |

PERFORMANCE

| | | | | |
|---|---|---|---|---|
| High pH | C | B | A | A |
| Kinetics | B | B | A | A |
| Selectivity | C | B | A | D |
| Biofilm | B | B | A | C |
| System Contamination | C | C | A | D |
| Bacterial Recovery | B | B | A | C |

ENVIRONMENTAL

| | | | | |
|---|---|---|---|---|
| THM | C | C | B | A |
| TOX | C | C | B | A |

Toxicity

| | | | | |
|---|---|---|---|---|
| of primary oxidant | B | A | A | C |
| of oxidation by-products | B | B | C | A |
| of oxidation reaction products | B | C | A | D |
| residual life (short life best) | C | B | C | A |

SAFETY

| | | | | |
|---|---|---|---|---|
| Easy to Use | B | B | C | B |
| Safe to Handle | B | B | C | B |

ECONOMICS

| | | | | |
|---|---|---|---|---|
| Clean System | A | B | B | C |
| Contaminated System | C | C | A | C |
| Cumulative GPA | 2.6 | 2.8 | 3.3 | 2.7 |

Many studies have been made comparing the disinfection efficiency of chlorine dioxide to chlorine. In one such study, varying dosages of chlorine dioxide or chlorine were added to solutions containing 15,000 viable cells/ml of E. coli at pH's of 6.5 and 8.5. The results are shown in FIG. 15. The abscissa is the time in seconds required to kill 99% of the viable bacterial cells. The ordinate is the initial dosage of oxidant.

Unlike chlorine, chlorine dioxide remains a true gas dissolved in solution. The lack of any significant reaction of chlorine dioxide with water is partly responsible for its retaining its biocidal effectiveness over a wide pH range. This property makes it a logical choice for cooling systems operated in the alkaline pH range, or cooling systems with poor pH control.

The disinfection requirements of an open recirculating industrial cooling system are markedly different from those of a potable water treatment facility. The disinfection goal of potable water facilities is the sterilization of water as measured by specific water borne pathogens. The goal of disinfection for industrial cooling systems is the removal or minimization of any biofilm, which retards heat transfer, causes biofouling, provides a place of agglomeration for marginally soluble or insoluble salts, and provides a place which nurtures and promotes the growth of highly corrosive anaerobic bacteria.

Many researchers have cited the excellent biofilm removing properties of chlorine dioxide. In at least one previously reported case history, the introduction of chlorine dioxide into a heavily fouled cooling system resulted in an increase in both turbidity and calcium. These were explained by a dispersing of the biofilm which both increased turbidity and released small calcium carbonate particulates which had been trapped in the biofilm.

Other industries have made use of the excellent biofilm removal properties of chlorine dioxide, particularly the food industry. Small cooling towers, frequently contaminated by food products or by-products, have tremendous slime forming potential. Chlorine dioxide has achieved widespread usage in such systems, due to its excellent biofilm dispersing/bacterial disinfecting properties.

Chlorine Dioxide Combined with a Halogen

U.S. Pat. No. 5,464,636 (the '636 Patent) discloses a means of reducing the concentration of bromide donor in a recirculating system by optimizing the ratio of hypochlorite to bromide ions to induce re-activation of the bromide in the recirculating water thereby improving cost effectiveness of the bromine treatment. The '636 Patent demonstrates a means of optimizing the cost-effectiveness of using bromine-based biocides by re-activating the bromide in the recirculating water. However, the '636 Patent fails to describe the synergistic effects of combining chlorine dioxide with bromine based biocide. Also, in highly stressed systems where bromine is more effective than chlorine (such as systems contaminated with ammonia, hydrocarbons and the like), residual chlorine is readily consumed to produce chloramines and trihalomethanes which in effect inactivate the chlorine. The composition disclosed in the '636 Patent is therefore only economical as a regenerative bromine treatment application in a system experiencing low chlorine demand, in which case the added expense of bromine is unwarranted. This is illustrated in the following comparison of oxidizing biocides:

| System Type | pH | Effectiveness of Biocides |
|---|---|---|
| Clean | 6.8-8.0 | Cl₂ < NaOCl < HOCl + NaBr < ClO₂ < |
| | | BCDMH < ozone |
| | 8.0-9.3 | HOCl + NaBr < ClO₂ < BCDMH < Cl₂ < |
| | | NaOCl < ozone |
| High Organic | 6.8-9.3 | ClO₂ < HOCl + NaBr < BCDMH < Cl₂ < |
| Load | | NaOCl < ozone |
| Ammonia | 6.8-9.3 | ClO₂ < HOCl + NaBr < BCDMH < Cl₂ < |
| Contamination | | NaOCl < ozone |

[values obtained from G. D. Simpson, et al., “A Focus on Chlorine Dioxide: The “Ideal” Biocide,” Unichem International, Inc.]

Hypobromous acid also dissociates with pH. The dissociation curve is essentially equivalent to that of chlorine. Its curve is offset by about 1 pH unit toward the alkaline range from that of hypochlorous acid. For example, the pH of 50% dissociation of the hypohalous acid to the hypohalite anion is about 7.5 and 8.7 for chlorine and bromine, respectively.

Bromine reacts with amines and ammonia. Unlike chlorine, bromamines largely retain their biocidal effectiveness, being almost as effective as hypobromous acid. In addition, the bromamines formed have relatively short half-lives, thus eliminating the need for dechlorination in some plants.

Bromine has been shown to be significantly better than chlorine with regard to biofilm control, while others have found there to be little difference between chlorine and bromine.

Numerous studies have shown the synergistic effect of combining chlorine dioxide with free chlorine as well as byproducts of chlorine oxidation, i.e. chloramines.

The combined effect dramatically increases the inactivation rate of a variety of organisms.

The synergistic effect may be achieved by using any bromine derivative (e.g., Br₂, HOBr, OBr⁻) or chlorine derivative (e.g., Cl₂, HOCl, OCl⁻).

An environmentally protective coating may be formed around the binder layer to prevent the agglomerate composition from premature reaction or decomposition prior to carrying out the function of a reactor.

FIG. 6 and FIG. 7 illustrate compositions that can provide the synergistic effect provided by combining chlorine dioxide and free halogen.

The tablets illustrated in FIGS. 6 and 7 can be commercially produced using multi-layer tableting equipment such as a “Hata three-layer tableting press” sold by Elizabeth-Hata International, 14559 Route 30, 101 Peterson Drive, North Huntingdon, Pa. However, a Carver press can also be used for laboratory scale productions using established tableting techniques.

The composition of the invention is effective as a biocide and algaecide treatment for use in recirculated water systems such as industrial cooling systems and swimming pools. While the foregoing has been with reference to a particular embodiment of the invention, it will be appreciated by those skilled in the art that changes in this embodiment may be made without departing from the principles and spirit of the invention.

What is claimed is:

1. A slow dissolving composition for the controlled release of chlorine dioxide and free halogen for use in multi-tablet chemical dispensers for the treatment of recirculating systems, wherein the composition comprises:
a mixture of components comprising from 5-60 weight % of a chlorite donor, 39.9-94.9 weight % of a free halogen donor, and a gelling agent comprising from 0.1-10 weight % of gel-forming material; and
wherein, the chlorite conversion to chlorine dioxide is at least 70 weight %; and
wherein, the gel-forming material comprising at least one of a natural, semi-synthetic, and synthetic polymer; and
wherein the composition is in the form of a tablet.

2. The composition of claim 1, wherein the free halogen donor consist of at least one of: trichloroisocyanuric acid (TCCA), dichloroisocyanuric acid, bromochloroisocyanuric acid, dibromodimethyl hydantoin, bromochlorodimethyl hydantoin.

3. The composition of claim 1, wherein the chlorite donor comprises sodium chlorite.

4. The composition of claim 1, wherein the gel-forming material is polyvinyl alcohol.

5. The composition of claim 1, wherein the gelling agent comprises polyvinyl alcohol and a stiffening agent comprising boron.

6. The composition of claim 1, wherein the chlorite donor is coated with the gel-forming material or gelling agent.

7. The composition of claim 1, wherein at least one component is coated with the gel-forming material or gelling agent.

8. The composition of claim 6, wherein the chlorite donor is encapsulated with the gel-forming material or gelling agent.

9. The composition of claim 1, further including a pH buffer.

10. A slow dissolving composition for the controlled release of chlorine dioxide and free halogen for use in multi-tablet chemical dispensers for the treatment of recirculating systems, wherein the composition comprises:
a mixture of components comprising from 9-50 weight % of a chlorite donor, 40-90 weight % of a free halogen donor, and a gelling agent comprising from 0.1-10 weight % of gel-forming material; and
wherein, the chlorite conversion to chlorine dioxide is at least 70 weight %; and
wherein, the gel-forming material comprising at least one of a natural, semi-synthetic, and synthetic polymer; and
wherein the composition is in the form of a tablet.

11. The composition of claim 10, wherein the free halogen donor consist of at least one of: trichloroisocyanuric acid (TCCA), dichloroisocyanuric acid, bromochloroisocyanuric acid, dibromodimethyl hydantoin, bromochlorodimethyl hydantoin.

12. The composition of claim 10, wherein the chlorite donor comprises sodium chlorite.

13. The composition of claim 10, wherein the gel-forming material is polyvinyl alcohol.

14. The composition of claim 10, wherein the gelling agent comprises polyvinyl alcohol and a stiffening agent comprising boron.

15. The composition of claim 10, wherein the chlorite donor is coated with the gel-forming material or gelling agent.

16. The composition of claim 10, wherein at least one component is coated with the gel-forming material or gelling agent.

17. The composition of claim 15, wherein the chlorite donor is encapsulated with the gel-forming material or gelling agent.

18. A slow dissolving tablet composition for the controlled release of a biocidal solution comprising at least chlorine dioxide and free halogen, wherein the composition comprises:
a mixture of components comprising from 5-50 weight % of a chlorite donor, 40-90 weight % of a free halogen donor, and a gelling agent comprising from 0.1-10 weight % of gel-forming material; and
wherein, the chlorite conversion to chlorine dioxide is at least 70 weight %; and
wherein, the gel-forming material comprising at least one of a natural, semi-synthetic, and synthetic polymer; and
wherein, the chlorite donor is coated with at least some portion of the gel-forming material.

19. The composition of claim 18, wherein the gel-forming material is polyvinyl alcohol.

20. The composition of claim 18, wherein the gelling agent comprises polyvinyl alcohol and a stiffening agent comprising boron.
